(19) United States
(12) Patent Application Publication
(10) Pub. No.: US 2008/0259051 A1
(43) Pub. Date: Oct. 23, 2008

(54) DISPLAY DEVICE AND ELECTRONIC APPARATUS

(75) Inventor: Hitoshi OTA, Matsumoto-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/022,737

(22) Filed: Jan. 30, 2008

(30) Foreign Application Priority Data
Mar. 12, 2007 (JP) 2007-061506

(51) Int. Cl. G06F 3/042

(52) U.S. Cl. 345/175

(57) ABSTRACT

The invention provides a display device including: a light source that emits a plurality of light-source lights having intensities different from one another at points in time different from one another from a back side opposite a display surface that is pointed by pointing means toward the display surface; a detecting unit that is provided at the back side and functions to detect a plurality of reflected lights, which are obtained as a result of reflection of the plurality of light-source lights by the pointing means; and an identifying unit that identifies the position of the pointing means on the basis of each of a plurality of third images by calculating a finite difference value between brightness data of a first image that is generated on the basis of one reflected light among the plurality of reflected lights and brightness data of each of a plurality of second images that is generated on the basis of a plurality of other reflected lights among the plurality of reflected lights, the above-mentioned plurality of other reflected lights having an intensity that differs from that of the above-mentioned one reflected light, and then by generating each of the plurality of third images on the basis of the corresponding one of the plurality of calculated finite difference values.

### BACKGROUND

1. Technical Field

The present invention generally relates to the technical field of a display device. More particularly, the invention relates to a display device having an input sensing function such as a touch-panel-type liquid crystal device. In addition, the invention further relates to an electronic apparatus that is provided with such a display device.

2. Related Art

In the technical field pertaining to the invention, a variety of display devices having a so-called touch panel input function has been proposed so far. In the configuration of a touch-panel-type liquid crystal device, which is an example of such a display device having a touch panel input function, an optical sensor (i.e., light sensor, photo sensor) is provided for either each of a plurality of pixel units or each of a plurality of groups of pixel units, where each group thereof is made up of a given number of pixel units. With such a configuration, in addition to its basic function of displaying an image by using light that transmits through the pixel units, a liquid crystal device having a touch panel function of the related art allows a user to input information by means of pointing means (In the following description, the pointing means may be referred to as a “pointing object” with no intention to limit the technical scope of the invention as long as the context allows). While liquid crystal device having a touch panel function of the related art allows a user to input information through the functioning of photo detectors, which are light-sensitive pickup elements. Specifically, the photo detectors such as optical sensors detect either the touching of a variety of pointing objects such as a finger of a user or other pointing member, though not limited thereto, onto the display surface of the liquid crystal device or the moving of such a pointing object over the display surface of the liquid crystal device. By this means, the user can input information into the liquid crystal device. A photo diode (photodiode) or other semiconductor element is a typical example of a photo detection optical sensing element. In the typical configuration of a touch-panel-type liquid crystal device of the related art, each photo diode is electrically connected to the corresponding capacitative element. With such a configuration in accordance with a change in the amount of incident light that enters through the display surface of the liquid crystal device, the amount of electric charge that is accumulated in the capacitative element also changes. The related-art liquid crystal device having an input function detects a voltage applied between a pair of electrodes of a capacitative element so as to generate the image data of a pointing object, which is the target of image pickup. In this way, the related-art liquid crystal device having an input function acquires the image of the pointing object.

In a plan view, each of the photo detectors such as optical sensors or the like is arranged inside a non-open region that provides isolation between each two adjacent ones of open regions of pixels so as not to obstruct image display. Herein, the term “open region” means an aperture region in each of pixels of an image display area, that is, a region which transmits light that actually contributes to display, whereas the term “nor-open region” means a region which blocks and shuts off light.

In a bright ambient light condition, the related art liquid crystal device having an Input function detects a pointing object so as to identify an image thereof by recognizing the optical difference between the shade (shaded area) of the pointing object that either approaches the display surface or contacts the display surface and the blight ambient light (bright area). On the other hand, in a dark ambient light condition, the related-art liquid crystal device having an input function detects a pointing object so as to identify an image thereof by recognizing the optical difference between outside light (i.e., external light) and reflected light. Herein, the reflected light is obtained by emitting detection light (i.e., internal light) toward the pointing object so that it reflects the detection light.

JP-A-2004-318819 discloses a display device that is capable of identifying the position of a variety of pointing objects such as a finger of a user or other pointing member. Specifically, the related-art display device disclosed in JP-A-2004-318819 picks pan image of a pointing object that is pointed to the display surface thereof for each of a plurality of pixel units by means of an optical sensor, and then acquires a coordinate that indicates the position of the pointing object on the display surface on the basis of image data of the picked-up image. JP-A-2004-118819 further proposes an information terminal device that is provided with such a display device. Another patent publication, for example, JP-A-2006-238053, proposes a flat panel display device that is capable of identifying a coordinate that indicates the position of a light-shielding object such as a pointing member, which shuts off outside light. The above-identified patent publication further proposes an image acquisition method that can be applied to such a display device.

However, the related-art display device that is disclosed in JP-A-2004-318819 or JP-A-2006-238053 has not addressed a technical problem of a difficulty in detecting the position of a pointing object with a high precision under a certain light condition. Specifically, in the configuration of a display device that is disclosed in these patent publications, since the level of an electric current for detection that flows through an optical sensor is weak, it could become practically impossible, or at best difficult, to detect the position of a pointing object such as a finger with a high precision depending on a change, variation, or fluctuation in the optical intensity of outside light that irradiates the display surface. For example, in a dark ambient light condition such as an indoor condition where the optical intensity of external light is comparatively small, the intensity of detection light (i.e., reflected light) that is reflected by a pointing object is not distinctively different from that of external light. In such a situation, it is at best difficult to differentiate the detection light that is reflected by the pointing object from external light. That is, this makes it difficult for an optical sensor to recognize the difference between such weak external light and the detection light that is reflected by the pointing object, the location of which is supposed to be identified. Therefore, under such a condition, it is practically impossible or at best difficult, to identify the position of the pointing object with a high precision.

In addition, if a control signal that controls the operation of optical sensors is used as disclosed in JP-A-2004-318819, it becomes necessary to provide an additional circuit such as a voltage level adjustment circuit or a timing adjustment circuit that controls optical detection time. Therefore, the technique taught in JP-A-2004-318819 has a further disadvantage in that it requires more complex circuit configuration of a control circuit that controls the operation of optical sensors.

Moreover, in the technical field of a display device having an input sensing function such as a touch-panel-type liquid crystal device, there is a strong demand for a technique that achieves the positional identification of a pointing object such as a finger, though not limited thereto, which touches or approaches the display surface thereof, with a high precision without being adversely affected by ambient condition in which the display device is operated, thereby offering a user a benefit of enhanced information input precision.

### SUMMARY

An advantage of some aspects of the invention is to provide a display device such as a liquid crystal device that is capable of identifying the position of pointing means such as a finger, though not limited thereto, with a high precision without requiring, for example, a complex configuration of a control circuit that controls the operation, of sensors. The invention further provides, advantageously, an electronic apparatus that is provided with such a display device.

In order to address the above-identified problem without any limitation thereto, the invention provides, as a first aspect thereof, a display device including: a light source that emits a plurality of light-source lights having intensities different from one another at points in time different from one another from a back side opposite a display surface that is pointed by pointing means toward the display surface; a detecting section that is provided at the back side and functions to detect a plurality of reflected lights, which are obtained as a result of reflection of the plurality of light-source lights by the pointing means; and an identifying section that identifies the position of the pointing means on the basis of each of a plurality of third images by calculating a finite difference value between brightness data of a first image that is generated on the basis of one reflected light among the plurality of reflected lights and brightness data of each of a plurality of second images that is generated on the basis of a plurality of other reflected lights among the plurality of reflected lights, the above-mentioned plurality of other reflected lights having an intensity that differs from that of the above-mentioned one reflected light, and then by generating each of the plurality of third images on the basis of the corresponding one of the plurality of calculated finite difference values.

In the configuration of a display device according to the first aspect of the invention, at the time of operation thereof, the light source emits a plurality of light-source lights having intensities different from one another at points in time different from one another from a back side opposite a display surface that is pointed by pointing means such as a finger of a user or other pointing member, though not limited thereto, toward the display surface. The light source can be configured as, for example, a planar light source unit that is capable of emitting a “flat” light-source light toward the display surface. Such a planar light source unit may have a two-dimensional array of a plurality of dot-pattern light source elements.

The detecting section is provided, for example, at the back-panel side. The detecting section detects a plurality of reflected lights, which are obtained as a result of reflection of the plurality of light-source lights by the pointing means. Specifically, a set of light-source lights; that is emitted toward the pointing object that touches the display surface or approaches the display surface among a plurality of sets of light-source lights that are emitted at points in time different from one set to another set is reflected as a set of reflected lights from the pointing object on or near the display surface toward the back-panel side at a timing depending on a timing of emission thereof. Therefore, a regional portion of the light-source lights that is irradiated on the pointing means on or near the display surface is detected as a result of reflection thereof.

The identifying section identities the position of the pointing means on the basis of each of a plurality of third images by calculating a finite difference value between brightness data of a first image that is generated on the basis of one reflected light among the plurality of reflected lights and brightness data of each of a plurality of second images that is generated on the basis of a plurality of other reflected lights among the plurality of reflected lights; the above-mentioned plurality of other reflected lights having an intensity that differs from that of the above-mentioned one reflected light, and then by generating each of the plurality of third images on the basis of the corresponding one of the plurality of calculated finite difference values.

Each of the above-mentioned one reflected light and the above-mentioned plurality of other reflected lights is obtained as a result of reflection of the corresponding one the plurality of light-source lights by the pointing means that are emitted from the light source at points in time different from one to another. The detecting section detects these reflected lights at points in time different from one to another. For example, since the plurality of light-source lights have intensities that differ from one to another, assuming that the intensity of outside light that is incident on the display surface at the periphery of the pointing means without being shut off by the pointing means is at a constant level, the brightness data of the first image that is obtained on the oasis of the above-mentioned one reflected light and the brightness data of the plurality of second images each of which is obtained on the basis of the corresponding one of the above-mentioned plurality of other reflected lights differ from each other (one another).

The intensity of the above-mentioned one reflected light that is reflected by the pointing means such as a finger and the direction of reflection thereof as well as the intensity of the above-mentioned plurality of other reflected lights each of which is reflected by the pointing means and the direction of reflection thereof differ from each other (one another, depending on the respective intensities of the plurality of light-source lights. Therefore, depending on the relative optical intensities of the reflected lights and the outside light, the brightness data of the first image that contains the image portion and the brightness data of the plurality of second images each of which contains the image portion that defines the outline of the pointing means differ from each other (one another). On the other hand, the brightness data of the regional portion of the first image where the outside light is detected is substantially the same as the brightness data of the regional portion of the plurality of second images where the outside light is detected.

Therefore, as described in detail later, as a result of the calculation of a finite difference value therebetween, it is possible to remove a noise component that is attributable to the outside light in the third image. By this means, it is possible to increase a precision in the positional identification of the pointing means. In addition, in the configuration of a display device according to the first aspect of the invention, even when the intensity of outside light changes, the image region that is formed on the basis of the outside light that is not shut off by the pointing means is cancelled in the third image in the process of the calculation of a finite difference value between the first image and the second image, a more detailed explanation of which will be given later. Therefore, advantageously, such a change in the intensity of the outside light does not adversely affect the identification of the position of the pointing means on the basis of the plurality of third images at all.

Moreover, with the configuration of a display device according to the first aspect of the invention, the intensity of outside light relative to the intensity of the reflected light has no effect on the identification of the position of the pointing means because it is possible to identify the image portion of the pointing means of each of the first image and the second image as long as there is a finite difference therebetween.

The image portion that defines the outline of the pointing means contained in each of the plurality of third images is a region where the image portion of the pointing means that is contained in the first image and the image portion of the pointing means that is contained in the second image overlap each other, where the first image and the second image constitute original images used for calculation and generation of the third image. For this reason, it can be reasonably considered that a partial area out of the entire area of the third image that is occupied by each of the image portions of the pointing means contained in the third image is substantially equal to the partial area out of the entire area of the display surface that is actually occupied by the pointing means.

Furthermore, in the configuration of a display device according to the first aspect of the invention described above, it is not necessary to provide any additional circuit or adjusting the voltage levels of optical sensors or to provide any additional circuit for adjusting the optical detection timing. Therefore, since a display device according to the first aspect of the invention does not require any more complex circuit configuration of a control circuit that controls the operation of optical sensors, it features simplified circuit configuration of the device as a whole.

Therefore, with the configuration of a display device according to the first aspect of the invention described above, it is possible to identify the position of pointing means on the display surface thereof accurately with a simple circuit configuration regardless of the relative intensities of outside light and light-source light, which is achieved by cross-referencing the plurality of third images. Since a display device according to the first aspect of the invention described above is capable of detecting the position of pointing means accurately, a user can input various kinds of information therein with a high precision.

In the configuration of a display device according to the first aspect of the invention described above, it is preferable that the identifying section should identify the position of the pointing means by calculating an average value of the respective center coordinates of image portions of the pointing means contained in the plurality of the third images.

With such a preferred configuration, it is possible to identify the position of the pointing means along a surface direction on the display surface by calculating an average value of the center coordinates of the image portions of the pointing means each of which occupies a partial region of the third image.

It is preferable that a display device according to the first aspect of the invention described above should further include a substrate that is provided between the light source and the display surface; and a plurality of pixel units that constitutes a display region over the substrate, wherein the detecting section has a plurality of light-sensitive elements each of which is formed inside a non-open region that provides isolation between one open region and another open region of the pixel units in the display region.

In the preferred configuration of a display device according to the first aspect of the invention described above, the substrate is configured as a TFT array substrate in (i.e., over) which semiconductor elements such as pixel-switching TFTs are formed. In addition, the display device according to the first aspect of the invention having such a preferred configuration is formed as a liquid crystal device that has the TFT array substrate, a counter substrate that is provided opposite the TFT array substrate, and a liquid crystal layer that is sandwiched between the TFT array substrate and the counter substrate.

The plurality of pixel units is arrayed in a matrix pattern over the substrate. The plurality of pixel units constitutes a display region. In the referred configuration described above, the display surface is, for example, one of two surfaces of the counter substrate that does not face the liquid crystal layer. An image is displayed on an area of the display surface that overlaps the display region in accordance with the operation of the plurality of pixel units. Each of the light-sensitive elements is, for example, an optical sensor such as a photo diode, though not limited thereto. Since each of the light-sensitive elements is provided inside a non-open region that provides isolation between one open region and another open region of the pixel units in the display region, it never obstructs the operation of the pixel units. That is, the light-sensitive element never obstructs image display.

In the configuration of a display device according to the first aspect of the invention described above, it is preferable that the light source should further function as, in addition to its function as a detection light source, a display light source that emits display light for displaying an image in accordance with an image signal on the display surface.

With such a preferred configuration, since the light source has the double functions described above, it is not necessary to provide another separate light source that emits light for detecting the pointing means. Therefore, it is possible to simplify the configuration of a display device according to the first aspect of the invention.

In the configuration of a display device according to the first aspect of the invention described above, it is preferable that the light source should include light emitting diodes.

With such a preferred configuration, it is possible to accurately control the intensity of light-source light, which is achieved by individually setting the level of an input electric current that is supplied to these light emission diodes. In addition, the light source having light emitting diodes is capable of accurately controlling the duration of light emission for each of the light emitting diodes. Accordingly, in accordance with the intensity of each of reflected lights, it is possible to uniquely identify the brightness data of the first image and the brightness data of the plurality of second images on the basis of each of the reflected lights, which is reflected by the pointing means toward the light-sensitive elements.

In order to address the above-identified problem without any limitation thereto, the invention provides, as a second aspect thereof, an electronic apparatus that is provided with the display device having the configuration described above.

According to an electronic apparatus of this aspect of the invention, it is possible to embody various kinds of electronic devices that has a touch panel input function and are capable of providing a high-quality image display, including but not limited to, a mobile phone, an electronic personal organizer, a word processor, a direct-monitor-view-type video tape recorder, a workstations a videophone, a POS terminal, and so forth, because the electronic apparatus of this aspect of the invention is provided with the display device according to the above-described aspect of the invention. In addition, as an example of an electronic apparatus of this aspect of the invention, it is possible to embody an electrophoresis apparatus such as an electronic paper.

these and other features, operations, and advantages of the present invention will be fully understood by referring to the following detailed description in conjunction with the accompanying drawings.

### BRIEF DESCRIPTION OF THE DRAWINGS

The invention will be described with reference to the accompanying drawings, wherein like numbers reference like elements.

FIG. 1 is a plan view that schematically illustrates an example of the configuration of a display device according to an exemplary embodiment of the invention.

FIG. 2 is a sectional view taken along the line II-II of FIG. 1.

FIG. 3 is a block diagram that illustrates an example of the major circuit configuration of a display device according to an exemplary embodiment of the invention.

FIG. 4 is a block diagram that illustrates an example of the circuit configuration of a sensor control circuit unit.

FIG. 5 is an equivalent circuit diagram that illustrates an example of constituent elements and wirings in an image display region of a display device according to an exemplary embodiment of the invention.

FIG. 6 is another equivalent circuit diagram that illustrates an example of the circuit configuration of a sensor unit and a pixel unit.

FIG. 7 is a plan view that illustrates a plurality of pixels arrayed adjacent to one another in each of which a pixel electrode is formed, and further illustrates the corresponding data lines and the corresponding scanning lines.

FIG. 8 is a sectional view taken along the line VIII-VIII of FIG. 7.

FIG. 9 is a sectional view taken along the line IX-IX of FIG. 7.

FIG. 10 is a flowchart that illustrates a method for identifying the position of pointing means, which is performed by a display device according to an exemplary embodiment of the invention.

FIG. 11 is a diagram that schematically illustrates an example of optical paths for light-source light, reflected light, and outside light in the configuration of a display device according to an exemplary embodiment of the invention.

FIGS. 12A, 12B, 12C, 12D, and 12E is a set of conceptual diagrams that illustrates an example of images that are processed by the sensor control circuit unit.

FIG. 13 is a conceptual graph that Illustrates an example of plural sets of light-source lights shown along a time axis, where the light-source lights have optical intensities that differ from one set to another set thereof.

FIGS. 14A, 14B, 14C, 14D, and 14E are a set of diagrams that shows a variation pattern of images illustrated in the conceptual diagram of FIG. 12.

FIGS. 15A, 15B, and 15C is a set of conceptual diagrams that schematically illustrates the concept of cancellation of a noise contained in images acquired by means of photo diodes.

FIG. 16 is a perspective view that schematically illustrates an example of an electronic apparatus according to an exemplary embodiment of the invention.

FIG. 17 is a perspective view that schematically illustrates another example of an electronic apparatus according to an exemplary embodiment of the invention.

### DESCRIPTION OF EXEMPLARY EMBODIMENTS

With reference to accompanying drawings, exemplary embodiments of a display device and an electronic apparatus according to some aspects of the invention are explained below.

### 1: Display Device

### 1-1: General Configuration of Display Device

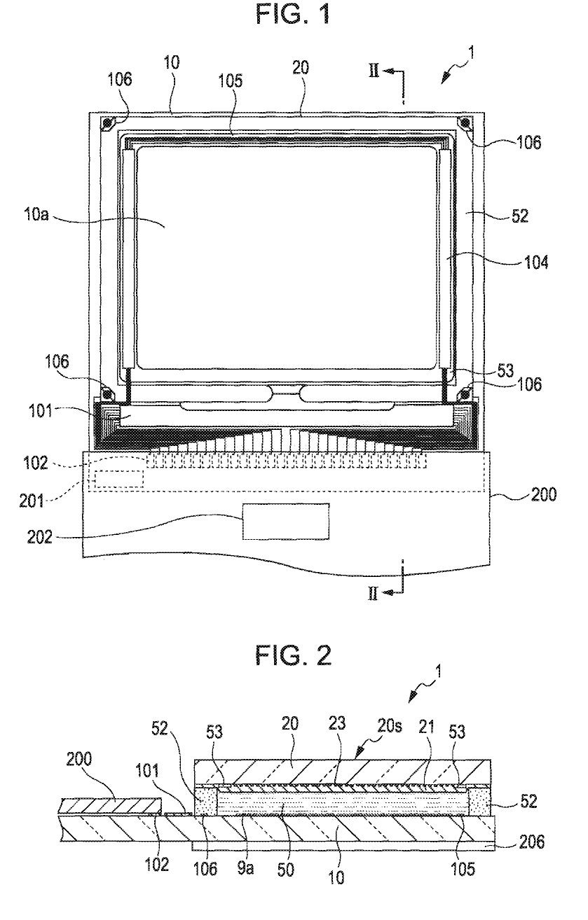

First of all, with reference to FIGS. 1 and 2, an explanation is given below of the general configuration of a liquid crystal device 1, which is an exemplary embodiment of a “display device” according to the invention. FIG. 1 is a plan view of the liquid crystal device 1 that schematically illustrates an example of the configuration of a TFT array substrate and various components formed or deposited thereon, which are viewed in combination from a certain point at the counter-substrate side. FIG. 2 is a cross sectional view taken along the line II-II of FIG. 1. The liquid crystal device 1 according to the present embodiment of the invention is provided with a built-in driving circuit. The liquid crystal device 1 according to the present embodiment of the invention operates in a TFT active matrix drive scheme.

As shown in FIGS. 1 and 2, in the configuration of the liquid crystal device 1 according to the present embodiment of the Invention, a TFT array substrate 00 and a counter substrate 20 are arranged opposite to each other. It should be noted that the TFT array substrate 10 (and the counter substrate 20) constitutes an example of a (pair of) “substrate(s)” according to the invention. A liquid crystal layer 50 is sealed between the TFT array substrate 10 and the counter substrate 20. The TFT array substrate 10 and the counter substrate 20 are bonded to each other with the use of a sealant material 52 that is provided at a sealing region around an image display region 10a. The image display region 10a is display area in which a plurality of pixel units is provided.

The sealant material 52 is made from, for example, an ultraviolet (UV) curable resin, a thermosetting resin, or the like, which functions to paste these substrates together. In the production process of the liquid crystal device, the sealant material 52 is applied onto the TFT array substrate 10 and subsequently hardened through an ultraviolet irradiation treatment, a heat treatment, or any other appropriate treatment. A gap material such as glass fibers, glass beads, or the like, are scattered in the sealant material 52 so as to set the distance (i.e., Inter-substrate gap) between the TFT array substrate 10 and the counter substrate 20 at a predetermined gap value.

Inside the sealing region at which the sealant material 52 is provided, and in parallel therewith, a picture frame light-shielding film 53, which has a light-shielding property and defines the picture frame region of the image display region 10a, is provided on the counter substrate 20. Notwithstanding the above, a part or a whole of the picture frame light-shielding film 53 may be provided at the TFT array substrate (10) side as a built-in light-shielding film. A peripheral region surrounds the image display region 10a. In other words, in the configuration of the liquid crystal device 1 according to the present embodiment of the invention, an area that is farther than the picture frame light-shielding film 53 when viewed from the center of the TFT array substrate 10, that is, an area that is not inside but outside the picture frame light-shielding film 53, is defined as the peripheral region.

Among a plurality of sub-peripheral regions that make up the peripheral region described above, a data line driving circuit 101 and external circuit connection terminals 102 are provided at one sub-peripheral region which lies outside the sealing region at which the sealant material 52 is provided in such a manner that these data line driving circuit 101 and external circuit connection terminals 102 are provided along one of four sides of the TFT array substrate 10. A pair of scanning line driving circuits 104 is provided along two of four sides thereof that are not in parallel with the above one side in such a manner that each of the scanning line driving circuits 104 is enclosed by the picture frame light-shielding film 53. In addition to the above, a plurality of electric wirings 105 is provided along the remaining one side (i.e., one that is parallel with the first-mentioned side) of the TFT array substrate 10 in such a manner that the plurality of electric wirings 105 is enclosed by the picture frame light-shielding film 53 so as to connect one of the pair of the scanning line driving circuits 104 that are provided outside the image display region 10a, along the second-mentioned two sides to the other thereof.

A sensor control circuit unit 201 is formed in the peripheral region over the TFT array substrate 10. The sensor control circuit unit 201 controls a sensor unit that includes optical sensors. A more detailed explanation of the sensor unit will be given later. The external circuit connection terminals 102 are connected to the connection terminals of a flexible printed circuit (hereafter abbreviated as “FPC”) 200, which is an example of connection means that provides an electric connection between external circuits and the liquid crystal device 1. The liquid crystal device 1 has a backlight. A backlight control, circuit unit 202 controls the backlight of the liquid crystal device 1. The backlight control circuit unit 202 has an IC circuitry and the like that is formed on the FPC 200. It should be noted that each of the sensor control circuit unit 201 and the backlight control circuit unit 202 might be configured as a built-in circuit of the liquid crystal device 1. Or, alternatively, each of the sensor control circuit unit 201 and the backlight control circuit unit 202 may be configured as an external circuit that is separated from the liquid crystal device 1.

Inter-substrate conductive material 106, which functions as conductive terminals that connect one substrate with another, are provided at four corners of the opposite substrate (i.e., counter substrate 20. On the other hand, another set of inter-substrate conductive terminals is provided also on the TFT array substrate 10 at positions each of which is opposite to the corresponding one of the four conductive terminals of the opposite terminal 20. With such a structure, it is possible to establish electric conduction between the TFT array substrate 10 and the counter substrate 20.

As illustrated in FIG. 2, a layered structure (i.e., lamination structure) that includes laminations of TFTs for pixel switching, which are driving/driver elements, and of wirings/lines such as scanning lines, data lines, and the like is formed on the TFT array substrate 10. Pixel electrodes 9a are formed at a layer above the lamination structure described above. An orientation film (i.e., alignment film) is deposited on the pixel electrodes 9a. On the other hand, a counter electrode 21 is formed on the counter substrate 20. A light-shielding film 23 that has either a grid pattern or stripe pattern is formed thereon. At the uppermost layer of a lamination structure formed on the counter substrate 20, an orientation film is formed. The liquid crystal layer 50 is made of liquid crystal that consists of, for example, a mixture of one or more types of nematic liquid crystal element. Such a liquid crystal takes a predetermined orientation state between a pair of the above orientation films (alignment films). An image is displayed on a display surface 20s of the liquid crystal device 1. The display surface 20s is one of two surfaces of the counter substrate 20 that does not face the liquid crystal layer 50. In order to simplify explanation, a polarizing sheet (i.e., polarizing film) and a color filter are not illustrated in the drawing. If it is assumed that a polarizing sheet and a color filter are formed on the counter substrate 20, the uppermost surface layer of the liquid crystal device 1 constitutes its display surface.

The liquid crystal device 1 is provided with a backlight 206. As illustrated in the drawing, the backlight 206 is provided below the TFT array substrate 10. The backlight 206 constitutes an example of a “light source” according to the invention. As understood from the above explanation and the drawing, the backlight 206 is provided at the back-panel side that is remotest from the display surface 20s. The backlight 206 is configured as a two-dimensional array of semiconductor light emission elements that constitute a dot-pattern light source, which are an example of light emitting diodes. The backlight 206 may be configured to include light emitting diodes such as organic electroluminescent (EL) elements or the like. Alternatively, the backlight 206 may be configured as a side-light-type one having a light guiding body. In such a configuration, the light guiding body receives light coming from a light source that is provided at a side and then outputs “flat” (i.e., planar, surface) light.

It should be noted that other functional circuits may also be provided on the TFT array substrate 10 illustrated in FIGS. 1 and 2 in addition to driving circuits such as the above-described data line driving circuit 101, the scanning line driving circuit 104, and so on, including but not limited to, a sampling circuit that samples an image signal on an image signal line to supply the sampled signal to a data line, a pre-charge circuit that supplies a pre-charge signal having a predetermined voltage level to each of the plurality of data lines prior to the supplying of an image signal, a test circuit for conducting an inspection on the quality, defects, etc., of the electro-optical device during the production process or before shipment, and so forth

### 1-2: Circuit Configuration of Display Device

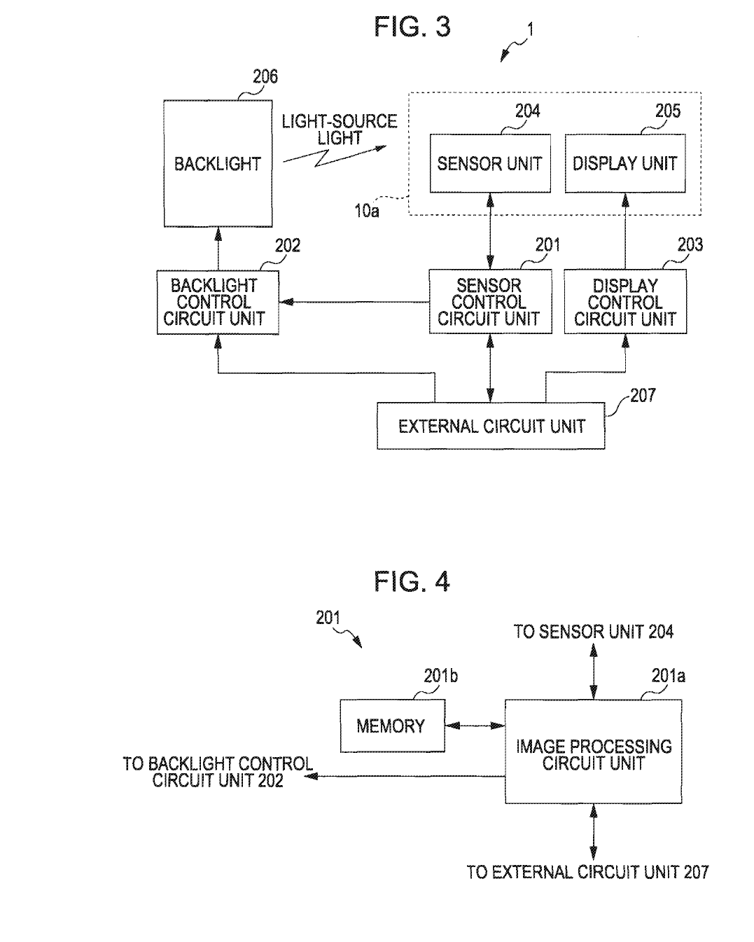

Next, with reference to FIGS. 3 and 4, an exemplary circuit configuration of the liquid crystal device 1 is explained below. FIG. 3 is a block diagram that illustrates an example of the major circuit configuration of the liquid crystal device 1. FIG. 4 is a block diagram that illustrates an example of the circuit configuration of the sensor control circuit unit 201.

As illustrated in FIGS. 3 and 4, the liquid crystal device 1 is provided with the sensor control circuit unit 201, the backlight control circuit unit 202, a display control circuit unit 203, a sensor unit 204, a display unit 205, and the backlight 206.

The display unit 205 is made up of a plurality of pixel units that are formed in the image display region 10a over the TFT array substrate 10. The display control circuit unit 203 includes the scanning line driving circuit 104 and the data line driving circuit 101. The display control circuit unit 203 controls the operation of the display unit 205 so that the display unit 205 displays an image corresponding to various kinds of signals including an image signal supplied from an external circuit unit 207.

The sensor unit 204 is an example of a detecting section, according to the invention. The sensor unit 204 as well as the display unit 205 is formed in the image display region 10a of the TFT array substrate 10. The sensor control circuit unit 201 constitutes an example of an identifying sections according to the invention. In addition to the function of controlling the operation of the sensor unit 204, the sensor control circuit unit 201 supplies, to the backlight control circuit unit 202, a signal for changing the optical intensity of light-source light that is emitted from the backlight 206.

With reference to FIG. 4A, an explanation of the detailed configuration of the sensor control circuit unit 201 is given below. As illustrated in FIG. 4, the sensor control circuit unit 201 is made up of, though not necessarily limited thereto, an image processing circuit unit 201a and a memory 201b. The image processing circuit unit 201a functions to process the image data of a pointing object such as a finger or the like at the time of detection of the pointing object. The memory 201b memorizes data that supplied from the image processing circuit unit 201a. The image processing circuit unit 201a reads out data stored in the memory 201.b at an appropriate timing for the purpose of utilizing the readout data for positional identification of the pointing object. A detailed explanation will be give later as to how the sensor control circuit unit 201 identifies the position of a pointing object such as a finger or the like on the display surface 20s.

Referring back to FIG. 3, the backlight control circuit unit 202 controls the operation of the backlight 206 on the basis of a signal supplied from each of the external circuit unit 207 and the sensor control circuit unit 201. Under the control of the backlight control circuit unit 202, the backlight 206 emits light-source light to the display surface 20s for detecting that a pointing object such as a finger or the like has been pointed to the display surface 20s of the liquid crystal device 1. In additions the backlight 206 doubles as, that is, further functions as, a display light source that emits display light to the display surface 20s so as to display an image corresponding to an image signal that is supplied from the external circuit unit 207 via the backlight control circuit unit 202. Since the backlight 206 has the double-functioning configuration described above, it is not necessary to provide another separate light source that emits light for detecting the pointing object. Therefore, it is possible to simplify the configuration of the liquid crystal, device 1.

### 1-3: Configuration of Pixel Units

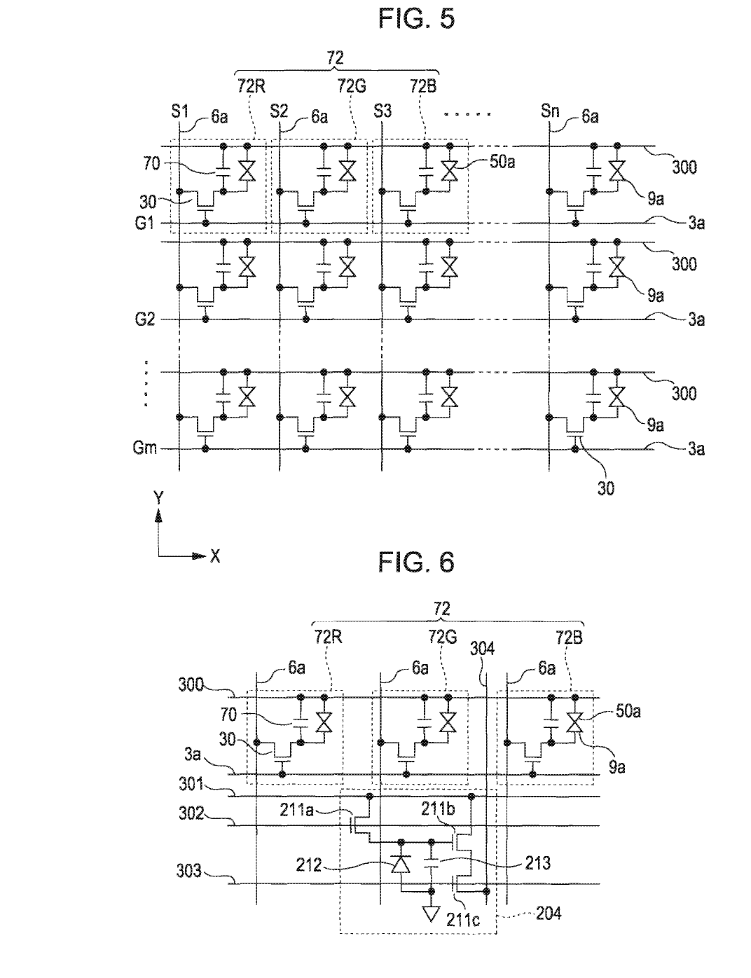

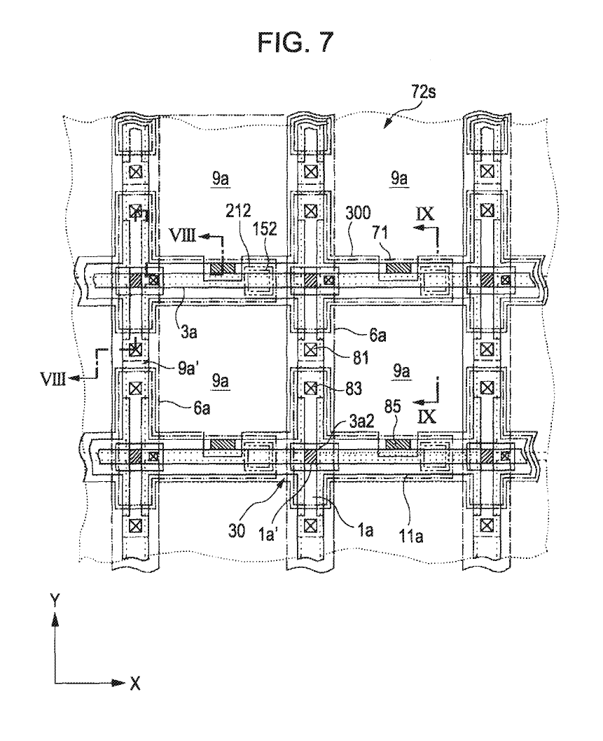

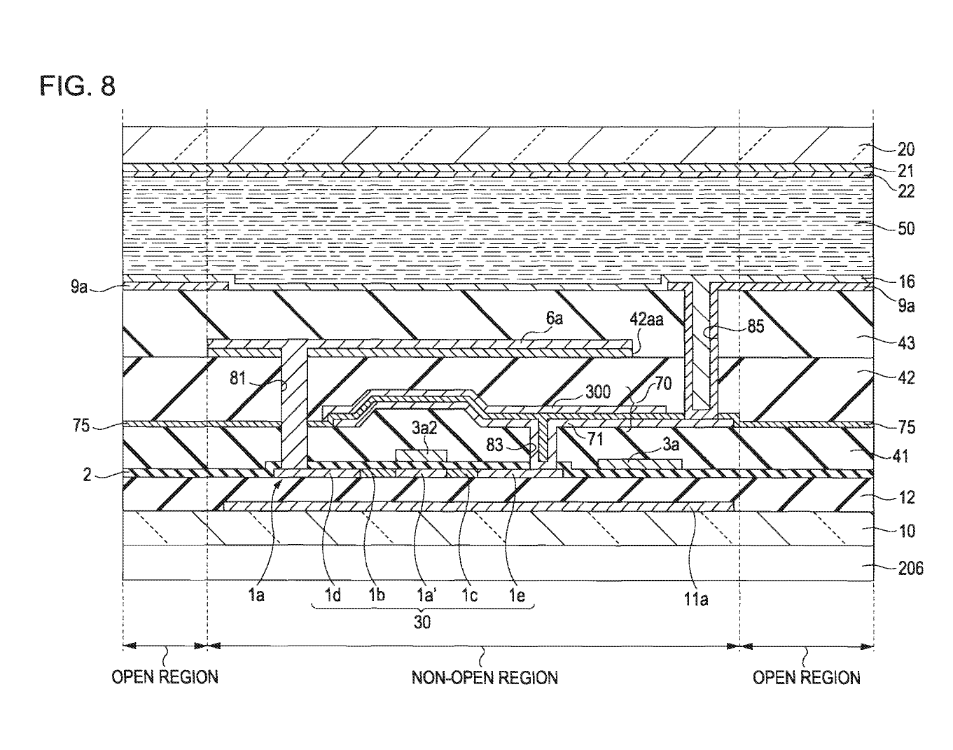

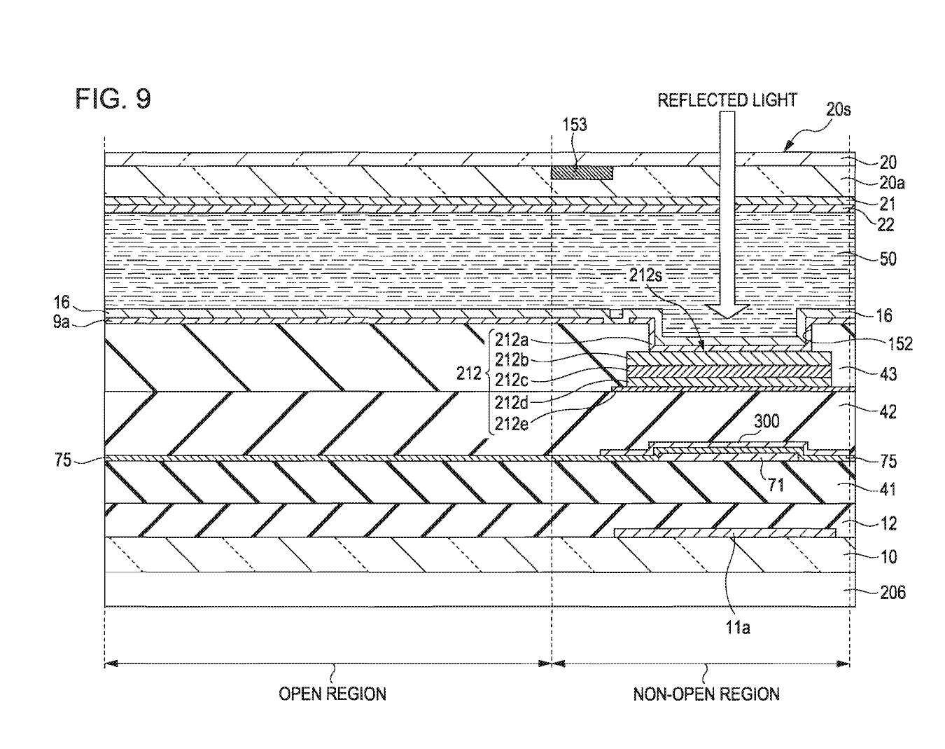

Next, with reference to FIGS. 5-9, a detailed explanation is given below of the configuration of the pixel units of the liquid crystal device 1. FIG. 5 is an equivalent circuit diagram that illustrates an example of constituent elements and wirings in a plurality of pixels that are arranged in a matrix pattern so as to constitute the image display region 10a of the liquid crystal device 1 according to the present embodiment of the invention. FIG. 6 is another equivalent circuit diagram that illustrates an example of the circuit configuration of one sensor unit 204 and the corresponding pixel unit. FIG. 7 is a plan view that illustrates a plurality of pixels arrayed adjacent to one another in each of which a pixel electrode is formed; and further illustrates the corresponding data lines and the corresponding scanning lines. FIG. 8 is a sectional view taken along the line VIII-VIII of FIG. 7. FIG. 9 is a sectional view taken along the line IX-IX of FIG. 7. In referring to FIGS. 8 and 9, it should be noted that different scales are used for layers/members illustrated in these drawings so that each of the layers/members has a size that is easily recognizable in each of these drawings.

As illustrated in FIG. 5, each one of a plurality of pixel units 72 that are arranged in a matrix pattern to constitute the image display region 10a of the liquid crystal device 1 is made up of a set of sub pixel units (sub pixel elements), specifically, a red sub pixel unit 72R that displays a red color component, a green sub pixel unit 72G that displays a green color component, and a blue sub pixel unit 72B that displays a blue color component. With such a pixel array configuration, the liquid crystal device 1 is capable of displaying a color image. Each of the sub pixel units 72R, 72C, and 72B has the pixel electrode 9a, a TFT 30, and a liquid crystal element 50a. The TFT 30 is electrically connected to the pixel electrode 9a so as to perform switching control on the pixel electrode 9a at the time of operation of the liquid crystal device 1. Each of data lines 6a to which image signals are supplied is electrically connected to the source of the TFT 30. Image signals S1, S2, . . . , and Sn that are written on the data lines 6a may be supplied respectively in the order of appearance herein (i.e., in the order of S1, S2, . . . , and Sn) in a line sequential manner. Alternatively, an image signal may be supplied to each of a plurality of groups of the data lines 6a, where each group consists of a bundle of the data lines 6a adjacent to each other (one another).

Each of scanning lines 3a is connected to the gate of the TFT 30. The liquid crystal device according to the present embodiment of the invention is configured to apply, at a predetermined timing and in a pulse pattern, scanning signals G1, G2, . . . , and Gm to the scanning lines 3a in the order of appearance herein in a line sequential manner. Each of the pixel electrodes 9a is electrically connected to the drain (region/electrode) of the TFT 30. When the switch of the T′T 30, which functions as a switching element, is closed for a certain time period, the image signal S1, S2, . . . , or Sn that is supplied through the data line 6a is written at a predetermined timing. After being written into liquid crystal via the pixel electrodes 9a, the image signals S1, S2, . . . , and Sn having a predetermined level are held for a certain time period between the pixel electrode 9a and the counter electrode 21 formed on the counter substrate 20.

Liquid crystal that is sealed in the liquid crystal layer 50 changes its orientation and/or its order of molecular association depending on the level of a voltage that is applied thereto. By this means, it modulates light to realize a gradation display. Under a “normally-white” mode, the optical transmittance (i.e., light transmission factor) with respect to an incident light beam decreases in accordance with a voltage applied on a sub-pixel-by-sub-pixel, basis (i.e., to each sub pixel), whereas, under a “normally-black” mode, the optical transmittance with respect to an incident light beam increases in accordance with a voltage applied on a sub-pixel-by-sub-pixel basis. Thus, when viewed as a whole, light having a certain contrast in accordance with an image signal is emitted from the liquid crystal device 1. In order to prevent the leakage of the image signals being held, a storage capacitor 70 is added in electrically parallel with the liquid crystal element 50a that is formed between the pixel electrode 9a and the counter electrode 21.

As illustrated in FIG. 6, the sensor unit 204 is provided for each of the pixel units 72 in the image display region 10a over the TFT array substrate 10. The sensor unit 204 is made up of, though not necessarily limited thereto, TFTs 211a, 211b, and 211c, a photo diode 212, and a capacitive element (i.e., capacitative element) 213. It should be noted that the photo diode 212 constitutes an example of a “light-sensitive element” according to the invention.

The gate of the TFT 211a is electrically connected to a sensor pre-charge control line 302. The source of the TFT 211a is electrically connected to a pre-charge line 301. The drain of the TFT 211a is electrically connected to the photo diode 212 and the capacitive element 213.

The TFT 211a is switched between an ON state and an OFF state in accordance with a pre-charge control signal that is supplied from the sensor control circuit unit 201 via the sensor pre-charge control line 302. The photo diode 212 is pre-charged by a pre-charge voltage that is supplied through the pre-charge line 301 and the TFT 211a.

The gate of the TFT 211b is electrically connected to the photo diode 212. The TFT 211.b functions as an amplification element that amplifies a change in the amount of electric charge accumulated in the photo diode 212. The change in the amount of accumulated electric charge that occurs in the photo diode 212 is attributable to reflected light that is detected by the photo diode 212.

The gate of the TFT 212c is electrically connected to a sensor output control line 303. The TFT 211c is switched between an ON state and an OFF state in accordance with an output control signal that is supplied via the sensor output control line 303. The TFT 211c outputs a signal corresponding to the change in the amount of accumulated electric charge that occurs in the photo diode 212 to the sensor control circuit unit 201 via a sensor output line 304.

Next, with reference to FIGS. 7-9, the specific configuration of sub pixel units 72s that make up a pixel unit is explained below.

As illustrated in FIGS. 7 and 8, a plurality of transparent pixel electrodes 9a is arrayed in a matrix pattern that is made up of a plurality of rows extending in the X direction and a plurality of columns extending in the Y direction over the TFT array substrate 10 of the liquid crystal device 1. The outline of each of the pixel electrodes 9a is shown as a dotted line portion 9a′ in the drawing. The data line 6a is provided in such a manner that it extends along the longitudinal edge, that is, vertical boundary, of the pixel electrode 9a, whereas the scanning line 3a is provided in such a manner that it extends along the latitudinal edge, that is, horizontal boundary, of the pixel electrode 9a. A user can input various kinds of information into the liquid crystal device 1 by touching the display surface 20s of the liquid crystal device with a pointing object such as a finger or the like, or pointing (i.e., indicating) a desired region of the display surface 20s thereof by means of such a pointing object.

As illustrated in FIG. 4, the scanning line 3a is formed at a region that is opposite to the channel region 1a′ of a semiconductor layer 1a. The channel region 1a′ of a semiconductor layer 1a is shown as a hatched area (i.e., with upward-sloping lines). At a position corresponding to each intersection where the data line 6a and the scanning line 3a intersect (traverse) each other, the pixel-switching TFT 30 is provided.

An underlying film 42aa is formed on the upper surface of a second inter-bedded insulation film 42. Prior to the formation of the underlying film 42aa thereon, the upper surface of the second inter-bedded insulation film 42 has been subjected to planarization processing. The data line 6a is formed on the underlying film 42aa. The data line 6a is electrically connected to the highly doped source region of the semiconductor layer 1a via a contact hole 81. The data line Ca and the inner portion of the contact hole 81 are made of Al (aluminum)—containing material such as Al—Si—Cu, Al—Cu, etc., or aluminum only, or alternatively, a multilayer film that consists of an Al layer and a TiN layer, or the like. The data line 6a has an additional light-shielding function so as to protect the TFT 30.

The storage capacitor 70 is made up of a lower capacitor electrode 71, an upper capacitor electrode 300, and a dielectric film 75. The upper capacitor electrode 300 and a part of the lower capacitor electrode 71 are opposed to each other with the dielectric film 75 being sandwiched therebetween. The lower capacitor electrode 71 of the storage capacitor 70 functions as a pixel-electric-potential-side capacitor electrode that is electrically connected to the pixel electrode 9a and further to the highly doped drain region 1e of the TFT 30. On the other hand; the upper capacitor electrode 300 of the storage capacitor 70 functions as a fixed-electric-potential-side capacitor electrode.

As illustrated in FIGS. 7 and 8, the upper capacitor electrode 300 is provided at a layer above the TFT 30. The upper capacitor electrode 300 functions as an upper light-shielding film (built-in light-shielding film) that shuts light off to protect the TFT 30. The upper capacitor electrode 300 is made of; for example, a metal or an alloy. As described above, the upper capacitor electrode 300 further functions as the fixed-electric-potential-side capacitor electrode. It should be noted that, in the configuration of the liquid crystal device 1 according to the present embodiment of the invention; the upper capacitor electrode 300 may be made of an elemental metal, an alloy, a metal silicide, a polysilicide, or any lamination thereof, which contains at least one of a metal including but not limited to titanium (Ti), chromium (Cr), tungsten (W), tantalum (Ta) molybdenum (Mo) palladium (Pd), and aluminum (Al). It should be noted that the upper capacitor electrode 300 might have a multi-tier structure. For example, the upper capacitor electrode 300 may be made of a lamination of a first film, for example, a conductive polysilicon film or the like, and a second film, for example, a metal suicide film or the like which contains a high melting point metal.

The lower capacitor electrode 71 may be configured as a conductive polysilicon film. Or, alternatively, the lower capacitor electrode 71 may be made of an elemental metal, an alloy, a metal silicide, a polysilicide, or any lamination thereof, which contains at least one of a metal including but not limited to titanium (Ti), chromium (Cr), tungsten (W), tantalum (Ta), molybdenum (Mo), palladium (Pd), and aluminum (Al). As has already been described above, the lower capacitor electrode 71 functions as the pixel-electric-potential-side capacitor electrode. In addition to its function as the pixel-electric-potential-side capacitor electrode, the lower capacitor electrode 71 has another function as a light absorption layer or a light-shielding film that is deposited between the upper capacitor electrode 300, which serves as the upper light-shielding film, and the TFT 30. Moreover, the lower capacitor electrode 71 has still another function of providing an electric relay connection between the pixel electrode 9a and the highly doped drain region 1e of the TFT 30. Notwithstanding the foregoing, the lower capacitor electrode 71 may be configured as a single-tier film or a multi-tier film that contains a metal or an alloy; the same applies for the upper capacitor electrode 300 as described above.

The dielectric film 75 that is sandwiched between the lower capacitor electrode 71 and the upper capacitor electrode 300 is made of, for example, a silicon oxide film such as an HTO (High Temperature Oxide) film or an LTO (Low Temperature Oxide) film, a silicon nitride film, or the like.

The upper capacitor electrode 300 extends from the image display region 10a, at which the pixel electrodes 9a are provided, to the periphery thereof. The upper capacitor electrode 300 is electrically connected to a constant electric potential source and is maintained at a constant electric potential.

A lower light-shielding film 11a is deposited in a grid array pattern at a layer below the TFT 30 with an underlying (i.e., base/ground) insulation film 12 being sandwiched therebetween. Accordingly, thanks to the presence of the lower light-shielding film 11a, it is possible to shut off a return light that enters from the TFT-array-substrate (10) side into the device, thereby effectively protecting the channel region 1a′ of the TFT 30 and its peripheral region. It should be noted that the lower light-shielding film 11a is made of an elemental metal, an alloy, a metal silicide, a polysilicide, or any lamination thereof, which contains at least one of a metal including but not limited to titanium (Ti), chromium (Cr), tungsten (W), tantalum (Ta) molybdenum (Mo), palladium (Pd), and aluminum (Al), that is, the same material as that of the upper capacitor electrode 300.

The underlying insulation film (i.e., layer) 12 has a function of layer-insulating the pixel-switching TFT 30 from the lower light-shielding film 11a. In addition thereto, the underlying insulation film 12 that is formed on the entire surface of the TFT array substrate 10 has a function of preventing any degradation in the characteristics of the pixel-switching TFT 30, which is attributable to roughness of the surface of the TFT array substrate 10 caused at the time of surface polishing thereof, any stains that remain after washing, or the like. The pixel electrode 9a is electrically connected to the highly doped drain region de of the semiconductor layer 1a via the lower capacitor electrode 71, which provides a relay connection therebetween, as well as via the contact holes 83 and 85.

As illustrated in FIGS. 7 and 8, in the configuration of the liquid crystal device 1 according to the present embodiment of the invention, the transparent TFT array substrate 10 and the transparent counter substrate 20 are arranged opposite to each other. The TFT array substrate 10 is made of, for example, a quartz substrate, a glass substrate, a silicon substrate, or the like. The counter substrate 20 is made of, for example, a glass subs-rate, a quartz substrate, or the like.

The pixel electrodes 9a are formed over the TFT array substrate 1. An alignment film (i.e., orientation film) 16 that is subjected to a predetermined orientation processing such as rubbing processing or the like is deposited on the pixel electrodes 9a. Each of the pixel electrodes 9a is configured as a transparent electrode, which is made of a transparent electro-conductive material such as indium tin oxide (ITO) or the like. The alignment film 16 is made of an organic film such as a polyimide film or the like.

The counter electrode 21 is formed on the entire region of the counter substrate 20. An alignment film 22 that is subjected to a predetermined orientation processing such as rubbing processing or the like is provided below (i.e., on) the counter electrode 21. The counter electrode 21 is made of a transparent electrode conductive material such as indium tin oxide (ITO) or the like. The alignment film 22 is made of an organic film such as a polyimide film or the like,

A light-shielding film that has either a grid pattern or stripe pattern may be formed on the counter substrate 20. With such a configuration, a combination of the afore-mentioned upper light-shielding film, which is the upper capacitor electrode 300, and the above-mentioned additional light-shielding film formed on the counter substrate 20 makes it possible to prevent incident light that enters from the counter substrate (20) side into the Liquid crystal device 1 from reaching the channel region 1a′ of the semiconductor layer 1a and its peripheral region thereof with an enhanced reliability.

The TFT array substrate 10 and the counter substrate 20 are adhered to each other so that the pixel electrodes 9a formed on the TFT array substrate 10 and the counter electrode 21 formed on the counter substrate 20 face each other. On addition to other constituent elements described above, the liquid crystal layer 50 is formed between the TFT array substrate IC and the counter substrate 20. When no electric field (i.e., voltage) is applied from the pixel electrode 9a, the liquid crystal layer 50 takes a predetermined orientation state between a pair of the above-mentioned orientation (i.e., alignment) films 16 and 22.

As illustrated in FIG. 8, the pixel-switching TFT 30 has a lightly doped drain (LDD) structure. The pixel-switching TFT 30 has the semiconductor layer 1a and a part of an insulation film 2. The semiconductor layer 1a of the pixel-switching TFT 30 consists of a channel region 1a′, a lightly doped source region 1b, a lightly doped drain region 1c, a highly doped source region 1d, and a highly doped drain region 1e. An electric field exerted from a gate electrode 3a2 and the scanning line 3a forms a channel at the channel region 1a of the semiconductor layer 1a. The insulation film 2 includes a gate insulation film that provides an electric insulation between the scanning line 3a and the semiconductor layer 1a. The lightly doped source region 1b, the lightly doped drain region 1c, the highly doped source region 1d, and the highly doped drain region 1e constitute the impurity region of the semiconductor layer 1a. An opposite pair of the lightly doped source region 1b and the lightly doped drain region 1c as well as another opposite pair of the highly doped source region 1d and the highly doped drain region 1e is formed approximately in a mirror symmetry pattern with respect to the channel region 1a′, that is, with the channel region 1a′ being the center of the mirror symmetry pattern.

The gate electrode 3a2 is made of an electro-conductive film such as a conductive polysilicon film. Or alternatively, the gate electrode 3a2 may be made of an elemental metal; an alloy, a metal silicide, a polysilicide, or any lamination thereof, which contains at least one of a metal including but not limited to titanium (Ti), chromium (Cr), tungsten (W), tantalum (Ta), molybdenum (Mo), palladium (Pd), and aluminum (Al). The gate electrode 3a2 is formed at a region that overlaps the channel region 1a, of the semiconductor layer 1a in a plan view with the insulation film 2 being interposed therebetween. It should be noted that the gate electrode 3a2 is formed. In such a manner that it does not overlap the lightly doped source region 1b and the lightly doped drain region 1c at all in a plan view. Therefore, a sufficient offset is secured between the highly doped source region 1d, the highly doped drain region 1e, and the gate electrode 3a2 in the configuration of the TFT 30.

One of two edges of the gate electrode 3a2 overlaps the boundary between the lightly doped source region 1b and the channel region 1a′ in a plan view. The other of two edges of the gate electrode 3a2 overlaps the boundary between the lightly doped drain region 1c and the channel region 1a′ in a plan view. By this means, parasitic capacitance that could be generated between the lightly doped source region 1b and the gate electrode 3a2 as well as between the lightly doped drain region 1c and the gate electrode 3a2 is reduced. Having such a configuration, the TFT 30 can operate in a nigh speed, which enhances the display performance of the liquid crystal device 1.

Since the liquid crystal device 1 has the upper capacitor electrode 300, which is formed at a layer above the gate electrode 3a2 in such a manner that the upper capacitor electrode 300 covers the TFT 30, in comparison with a case where it is the gate electrode 3a2 only that functions to shut light off to protect the lightly doped source region 1b and the lightly doped drain region 1c thereof, it is possible to protect the lightly doped source region 1b and the lightly doped drain region 1c thereof with a greater light-shielding reliability.

As explained above, since the TFT; 30 that features a reduced optical leakage current is employed in the configuration of the liquid crystal device 1, it is possible to reduce the occurrence of image display failures or image display problems such as flickers, though not limited thereto, thereby making it further possible to display a high-quality image. As mentioned earlier, the TFT 30 has an LDD structure. With such a configuration, it is possible to reduce the amount/level of an OFF-state current that flows in the lightly doped source region 1b and the lightly doped drain region 1c during the non-operating time of the TFT 30, and also to suppress the decrease in the amount/level of an ON-state current that flows during the operating time of the TFT 30. Thus, taking advantage of the LDD structure and the significantly reduced (i.e.; almost no) optical leakage current, the liquid crystal device offers image display with enhanced picture quality.

A first inter-bedded insulation film 41 is deposited on the insulation film 2, the scanning line 3a, and the gate electrode 3a2. The contact hole 11 penetrates through the first inter-bedded insulation film 41 to provide an electric connection to the highly doped source region 1d of the semiconductor layer 1a. The contact hole 83 penetrates through the first inter-bedded insulation film 41 to provide an electric connection to the highly doped drain region 1e thereof.

The lower capacitor electrode 71 and the upper capacitor electrode 30U are formed over the first inter-bedded insulation film 41. The second inter-bedded insulation film 42 is deposited over the lower capacitor electrode 71 and the upper capacitor electrode 300. The contact holes 81 and 85 go through the second inter-bedded insulation film 42.

The second inter-bedded insulation film 42 according to the present embodiment of the invention is made of, for example, a BPSG film. The upper surface of the second inter-bedded insulation film 42 according to the present embodiment of the invention is planarized after being subjected to a heat-fluidization treatment. Before being subjected to the heat-fluidization treatment, that is a immediately after the film formation process, there is a surface level difference in the upper surface of the second inter-bedded insulation film 42 because of the presence of underlying layer components, specifically, the storage capacitor 70, the TFT 30, the scanning line 3a, and the lower light-shielding film 11a that are formed below the second inter-bedded insulation film 42. However, since the upper surface of the second inter-bedded insulation film 42 is subjected to the heat-fluidization treatment, it is planarized (smoothed) without leaving any significant unevenness thereon. As a non-limiting modification, example thereof, the surface level difference in the upper surface of the second inter-bedded insulation film 42 may be reduced by means of a photosensitive acrylic resin or the like.

A third inter-bedded insulation film 43 is formed over the data line 6a in such a manner that the third Inter-bedded insulation film 43 covers the entire surface of the second inter-bedded insulation film 42. The contact hole 85 penetrates through the third inter-bedded insulation film 43. The third inter-bedded insulation film 43 is made of a BPSG film, though not limited thereto. The pixel electrode 9a is formed on the upper surface of the third inter-bedded insulation film 43. The alignment film 16 is formed on the pixel electrode 9a. As a non-limiting modification example thereof, the surface level difference in the upper surface of the third inter-bedded insulation film 43 may be reduced by means of a photosensitive acrylic resin or the like.

Next, with reference to FIGS. 7 and 9, the photo diode 212 is explained in detail below.

As illustrated in FIGS. 7 and 9, each of the photo diodes 212 is arranged inside the non-open, region that provides isolation between each two adjacent ones of open regions of pixels. As defined earlier, the term “open region” means an aperture region in each of pixels of the image display region 10a, that is, a region which transmits light that actually contributes to display, whereas the term “non-open region” means a region which blocks and shuts off light. The open region is an area through which display light (i.e., light for display) that is emitted from the backlight 206 transmits. The non-open region surrounds the open region. At the non-open region, an opaque film that does not transmit light, including but not limited to, the data line 6a, is formed. At the open region, display light that has been emitted from the backlight 206 is subjected to optical modulation in accordance with the orientation state of the liquid crystal layer 50. Then, the modulated light is outputted from the display surface 20s.

The photo diode 212 detects, in addition to outside light (i.e., external light, or incident light), light reflected by a pointing object that is in contact with the display surface 20s or located over the display surface 20s. The sensor control circuit unit 201 identifies the position of the pointing object on the basis of the optical intensity of the reflected light that has been detected by the photo diode 212 and the optical intensity of the outside light. The photo diode 212 has a lamination structure that is made up of, when viewed from the TFT array substrate (10) side, a lower electrode 212e, an n-type semiconductor layer 212d, a light-sensitive layer 212c, a p-type semiconductor layer 212b, and an upper electrode 212a, which are deposited in the order of appearance herein. That is, the photo diode 212 is configured as a PIN diode. Since the photo diode 212 is provided at the non-open region, which is an area that does not contribute to image display, the aperture ratio of a pixel is not lowered. Therefore, the photo diode 212 never obstructs the operation of a pixel unit. That is, the photo diode 212 never obstructs image display. A concave portion 152 is formed in a part of the surface of the third inter-bedded insulation film 43, where the above-mentioned part lies in the non-open region. The light-sensitive surface 212s of the photo diode 212 is exposed at the bottom surface of the concave portion 152. A black matrix 153 is formed on the counter substrate 20. The black matrix 153 partially defines the non-open region.

### 1-4: Positional Identification of Pointing Object Performed by Display Device

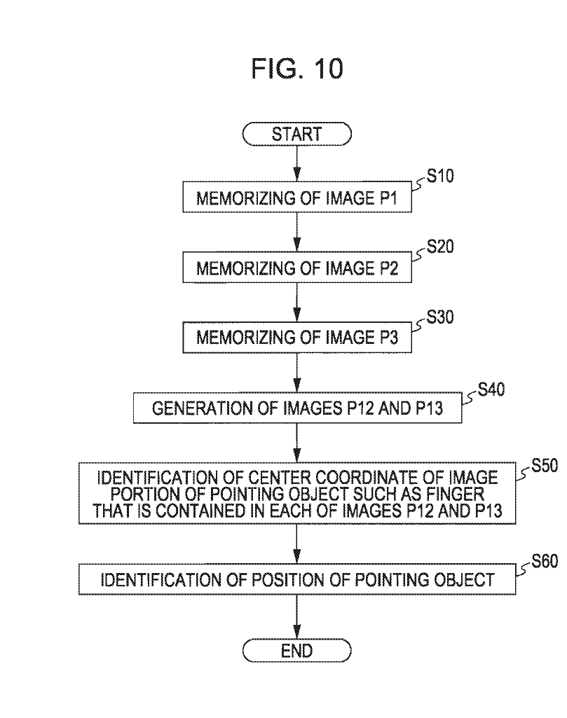

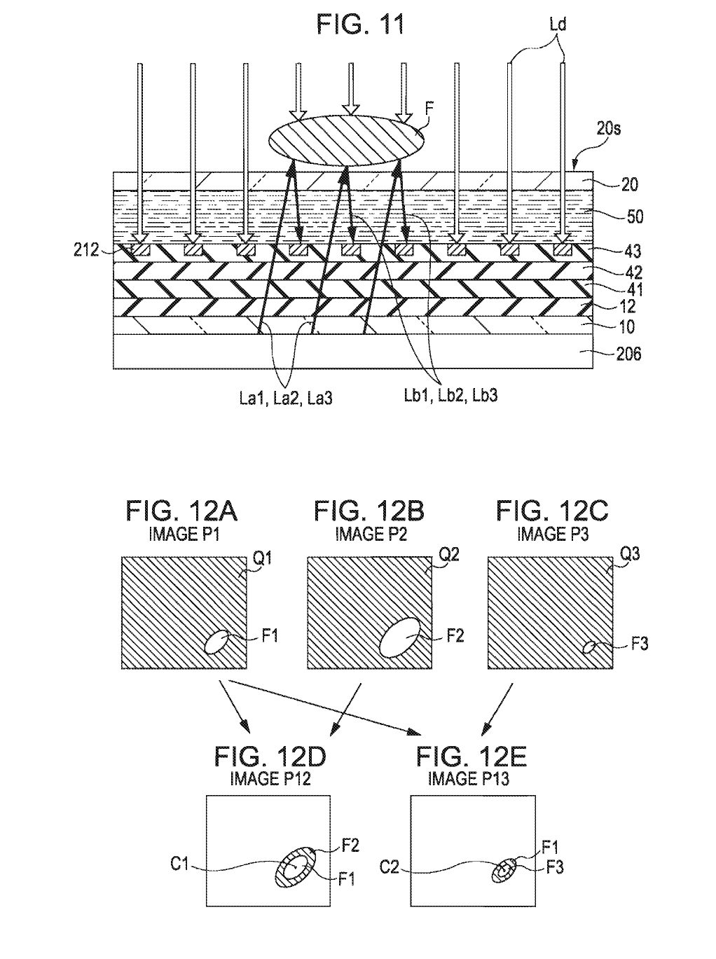

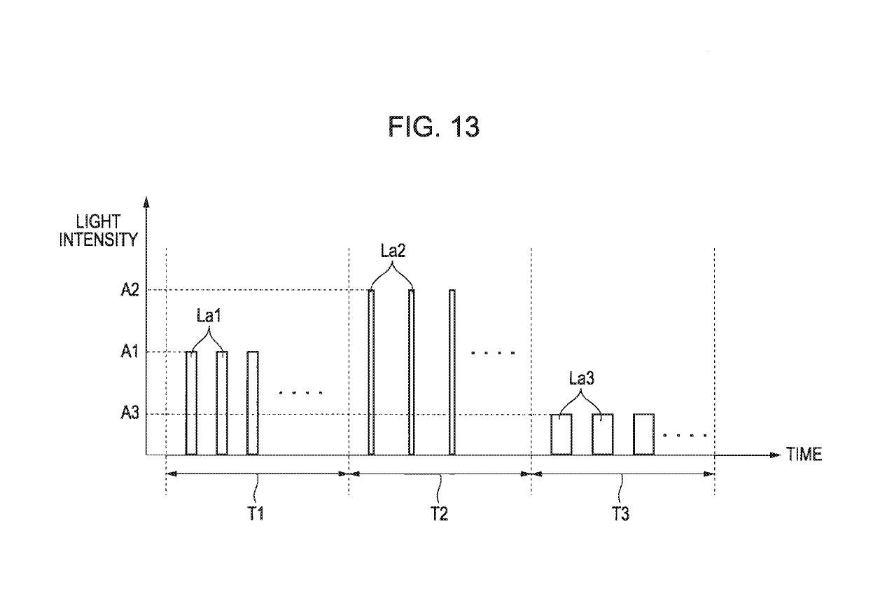

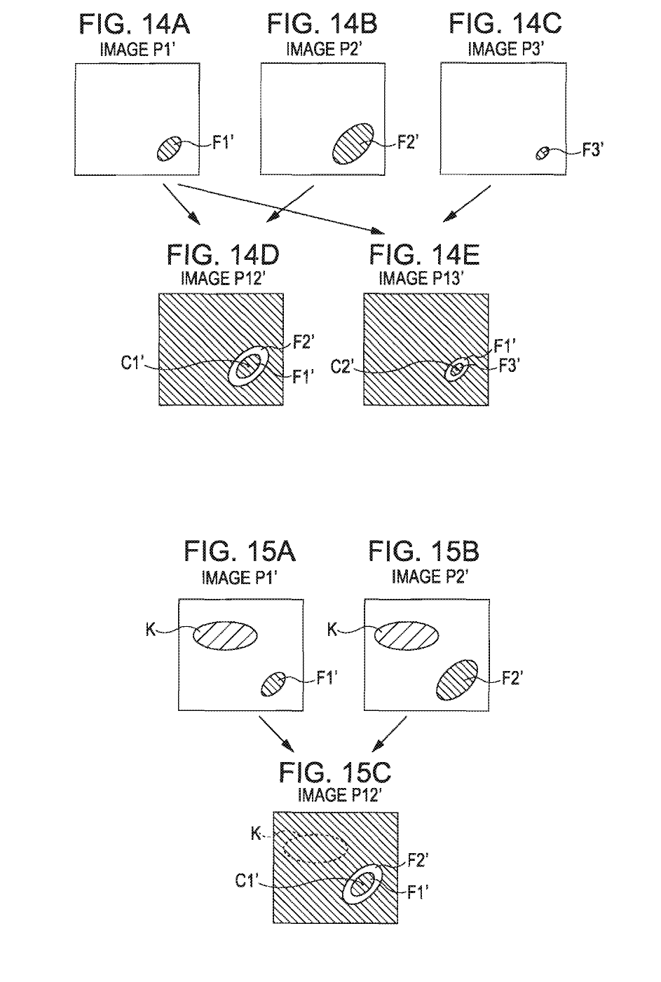

Next, with reference to FIGS. 10-15, an explanation is given below as to how the liquid crystal device 1 identifies the position of a pointing object. FIG. 10 is a flowchart that illustrates a method for identifying the position of a pointing object, which is performed by the liquid crystal device 1 according to the present embodiment of the invention. FIG. 11 is a diagram that schematically illustrates an example of optical paths for light-source light, reflected light, and outside light (the term “outside light” does not exclude indoor light) in the configuration of the liquid crystal device 1. FIGS. 12A, 12B, 12C, 12D, and 12E is a set of conceptual diagrams that illustrates an example of images that are processed by the sensor control circuit unit 201. It should be noted that, in FIG. 12, it is assumed that the optical intensity of light reflected by a pointing object such as a finger, though not limited thereto, is greater than that of outside light. FIG. 13 is a conceptual graph that illustrates an example of plural sets of light-source lights shown along a time axis, where the light-source lights have optical intensities that differ from one set to another set thereof. FIGS. 14A, 14B, 14C, 14D, and 14E are a set of diagrams that shows a variation pattern of images illustrated in the conceptual diagram of FIG. 12. FIGS. 15A, 15B, and 15C is a set of conceptual diagrams that schematically illustrates the concept of cancellation of a noise contained in images acquired by means of the photo diode 212.

In connection with the illustrations of FIGS. 10, 11, and 12, in order to detect a pointing object such as a finger, though not limited thereto, the backlight 206 emits a light gal having an optical intensity (i.e., light intensity) A1 from the back-panel side, which is opposite the display surface 20s, toward the display surface 20s. The light-source light La1 gets reflected at the surface of a finger F, which is a non-limiting example of the pointing object that is pointed to a certain arbitrary position on the display surface 20s. Then, as a result of reflection thereof, a reflected light Lb1, which is an example of “one reflected light” according to the invention, is detected by the photo diode 212. Concurrently with the detection of the reflected light Lb1, an external light Ld is detected by the photo diode 212 at a region that does not overlap the finger F on the display surface 20s. The sensor control circuit unit 201 acquires an output signal that is outputted from each of the photo diodes 212. Then, the sensor control circuit unit 201 generates an image P1, which contains an image portion F1 for (i.e., of) the finger F that corresponds to the light—source light La1 having the optical intensity A1 and an image portion Q1 that corresponds to the outside light Ld. The image P1 is an example of “a first image” according to the invention. The memory 201b acquires the brightness data (i.e., luminosity data) of the image P1 from the image processing circuit unit 201a, and stores the acquired data (step S10).

Next, the backlight 206 emits a plurality of light-source lights in a sequential manner toward the display surface 20s, where each of the plurality of sequential light-source lights has an optical intensity that is different from that of the light-source light La1.

Accordingly, the light-source light La1 and the plurality of subsequent light-source lights that has an optical intensity different from that of the light-source light La1 are emitted from the backlight 206 toward the display surface 20s in a non-concurrent manner, that is, at points in time different from one another.

While making reference to FIG. 13, an explanation is given below of the above-described light-source lights that have optical intensities different from one another and are emitted from the backlight 206 toward the display surface 20s at points in time different from one another.

As illustrated in FIG. 13, the light-source light La1 having the optical intensity A1, more specifically and exactly, a set of a plurality of the light-source lights La1 each having the optical intensity A1, is emitted in a pulse pattern during a first time period T1. After the elapsing of the first time period T1, the backlight 206 emits a set of a plurality of light-source lights La2 each having an optical intensity A2, or collectively and simply said, the light-source light Ta2 having the optical intensity A2, toward the display surface 20s in a second time period T2, which is subsequent to the first time period T1. Thereafter, the backlight 206 further emits a set of a plurality of light-source lights La3 each having an optical intensity A3 toward the display surface 20s in a third time period T3, which is subsequent to the second time period T2. As understood from the drawing, the optical intensity A2 of the light-source light La2 is the largest among the optical intensities A1, A2, and A3, whereas the optical intensity A2 of the light-source light La3 is the smallest. Since the backlight 206 is made up of light emitting diodes, though not limited thereto, the backlight 206 is capable of emitting these light-source lights La1, La2, and La3 each with an accurate optical intensity under the control of the backlight control circuit unit 202, which can individually set the level of an input electric current that is supplied to these light emitting diodes. In addition, the backlight 206 having light emitting diodes is capable of accurately controlling the duration of light emission for each of the light emitting diodes. Accordingly, in accordance with the optical intensity of each of reflected lights, it is possible to uniquely identify the brightness data of an image that contains the image portion for the finger F on the basis of each of the reflected lights, which are obtained as a result of reflection of the light-source lights La1, La2, and La3 at (i.e., by) the finger F.

As illustrated in FIG. 11, the reflected lights Lb2 and Lb3 are obtained as a result of reflection of the light-source lights La2 and La3 at the finger F, respectively. The reflected lights Lb2 and Lb3 constitute “a plurality of other reflected lights” according to the invention. The optical intensities of reflected lights Lb1, Lb2, and Lb3 are different from one another because the optical intensities of the corresponding light-source lights La1, La2, and La3 are different from one another. For this reason, the images of the finger F that are identified by detecting these reflected lights Lb1, Lb2, and Lb3 are also different from one another.

Referring back to FIGS. 10, 11, and 12, a further explanation as to how the liquid crystal, device 1 identifies the position of the pointing object is given below. After the memory 201b has stored the brightness data of the image P1, the backlight 206 emits the light-source lights La2 and La3 in a sequential manner. Then, the photo diode 212 detects the reflected lights Lb2 and Lb3. The image processing circuit unit 201a generates an image P2 that contains an image portion (F2) for the finger F corresponding to the reflected light Lb2, and then generates an image P3 that contains an image portion (F3) for the finger F corresponding to the reflected light L′b3 in a sequential manner. Each of the images P2 and P3 is an example of “a second image” according to the invention. The brightness data of the images P2 and P3 is sequentially stored into the memory 201b (steps S20 and Q30).

Each of the light-source lights La1, La2, and La3 is emitted in an ultra-short duration, which 1 is short enough so that the optical intensity of the outside light Ld does not change therein. Therefore, it is reasonably considered that the brightness level of the “background” image portions Q1, Q2, and Q3 of the images P1, P2, and P3 other than the finger image portions F1, F2, and F3 is constant.

As illustrated in FIGS. 12A, 12B, and 12C, the sizes of the image portions F1, F2, and F3 of the finger F that constitute a part of the images P1, P2, and PB, respectively, are different from one another because of the difference in the optical intensities of the reflected lights Lb1, Lb2, and Lb3.

Next, as illustrated in FIGS. 10 and 12, the image processing circuit unit 201a reads out the brightness data of the images P1, P2, and P3 from the memory 201b and then generates the images P12 and P13 (step S40). Each of the images P12 and P13 constitutes an example of “a third image” according to the invention. The image P12 is generated as a result of the calculation of a finite difference value between the brightness data of the image P1 and the brightness data of the image P2. On the other hand, the image P13 is generated as a result of the calculation of a finite difference value between the brightness data of the mage P1 and the brightness data of the image P3.

The image processing circuit unit 201a identifies the central coordinate for the image P12. Specifically as illustrated in FIG. 12, the image processing circuit unit 201a Identifies the coordinate of the center C1 of the image portion F1, which is a region where the image portion F1 of the finger F that is acquired on the basis of the reflected light Lb1 and the image portion F2 of the finger F that is acquired on the basis of the reflected light Lb2 overlap. On the other hand, the image processing circuit unit 201a identifies the central coordinate for the Image P13. Specifically, the image processing circuit unit 201a identifies the coordinate of the center C2 of the image portion F3, which is a region where the image portion F1 of the finger F that is acquired on the basis of the reflected light Lb and the Image portion F3 of the finger that is acquired on the basis of the reflected light Lb3 overlap (step S50). Since the image portion Q1 of the image P1, the image portion Q2 of the image P2, and the image portion Q3 of the image P3 have a “common” constant-level brightness data, these background regions are cancelled (i.e., offset) in the process of calculating a finite deference value so as to generate each of the images P12 and P153

Next, the image processing circuit unit 201a calculates the average value of the center coordinate C1 and the center coordinate C2 so as to identify the position of the finger F on the display surface 20s (step S60).

Through a series of processing described above, the liquid crystal device 1 is capable of detecting the position of a pointing object precisely. By this means, a user can input various kinds of information in accordance with the position of the finger F, which is a non-limiting example of the above-mentioned pointing object. As has already been described above, each set of the light-source lights that is emitted for identifying the position of a pointing object such as a finger is emitted in a pulse-like manner along a time axis. Therefore, in spittle of the difference in the optical intensities of these sets of light-source lights, it is possible to almost equalize the time-average optical amount/level of these sets of light-source lights with one another by adjusting each pulse width of these sets of light-source lights so that the difference is offset, thereby making it difficult for a user to visually perceive a brightness change therein with the naked eyes. Since the brightness change is not observed, there is not any substantial degradation in the quality of a display image. By this means, the liquid crystal device 1 according to the present embodiment of the invention makes it possible to identify the position of the pointing object such as a finger with accuracy without increasing the power consumption of a backlight. As illustrated in FIG. 1, the pulse width of the light-source light La3, which has the smallest optical intensity among the light-source lights of La1, La2, and La3 each of which is emitted in a pulse pattern, is larger than those of the light-source lights La1 and La2. On the other hand, the pulse width of the light-source light La2, which has the largest optical intensity among the light-source lights of La1, La2, and La3, is smaller than those of the light-source lights La1 and La3. With such a pulse configuration, the integration values of the light-source lights La1, La2, and La3, which are emitted in the time periods T1, T2, and 113, respectively, are substantially equal to one another. Therefore, there occurs almost no significant brightness change therebetween that can be perceived with the unaided eyes.

In addition, if the length of time for optical detection is set at a value smaller than the pulse width of the light-source light that is smallest among a plurality of light-source lights, the above-explained configuration has no adverse influence on the precision in the detection of light.

Next, referring to FIG. 14, a variation example of the positional identification method described above is explained below. In the following variation example; it is assumed that the optical intensity of light reflected by a pointing object is smaller than that of an outside light. That is, the relationship between the optical intensity of the reflected light and that of the outside light explained in the foregoing description of the positional identification method while referring to the flowchart of FIG. 10 is reversed in the following description.

As illustrated in FIG. 14, the images P1′, P2′, and P3′ are generated as a result of the optical detection of the reflected lights Lb1, Lb2, and Lb3, respectively, by the photo diode 212. In this example, it is assumed that the optical intensity of each of the reflected lights Lb1, Lb2, and Lb3 is smaller than that of the outside light Ld; for this reason, the brightness levels of the image portions F1′, F2′, and F3′ of the finger F, that is, the brightness levels of the finger image portions F1′, F2′, and F3′, are relatively small in comparison with those of the background image portions around the finger image portions F1′, F2′, and F3′, respectively. However, since it can be considered that the brightness level of the outside light Ld is constant, in the process of generating an image P12′ on the basis or a finite difference value between the brightness data of the image P1′ and the brightness data of the image P2′, the brightness of the peripheral (i.e., background) region around the finger image portion F1′ and the brightness of the peripheral region around the finger image portion F2 are offset with each other. In like manner, in the process of generating an image P13′ on the basis of a finite difference value between the brightness data of the image P1′ and the brightness data of the image P3′, the brightness of the peripheral region around the finger image portion F1′ and the brightness of the peripheral region around the finger image portion F3′ are offset with each other. Therefore; as a result of n calculation of an average value between the center coordinate C1′ of the image portion F1′, which is the region at which the image portion F1′ and the image portion F2′ overlap each other, and the center coordinate C2′ of the image portion F3′, which is the region at which the image portion. F1′ and the image portion F3′ overlap each other, it is possible to identify the position of the finger F′ with accuracy.

In the method for identifying the position of a pointing object such as a finger or the like according to the present embodiment of the invention described above, an average value of the center coordinates of image portions that define the respective outlines of the pointing object contained in the images P12 and P13 (or P12′ and P13′) is calculated. Notwithstanding the foregoing, it should be noted that the calculation of the average value of the center coordinates thereof is not an indispensable element of the invention. That is, in the positional identification method according to the invention, it is possible to identify the position of a pointing object with a satisfactory precision even without calculating an average value of the center coordinates thereof because it can be reasonably considered that a partial area out of the entire area of the image P12, P13 (or P12′, P13′) that is occupied by each of the image portions of the pointing object contained in the images P12 and P13 (or P12′ and P13′) is substantially equal to the partial area out of the entire area of the display surface 20s that is actually occupied by the pointing object.

In the configuration of the liquid crystal device 1 according to the present embodiment of the invention, it is not necessary to provide any additional circuit for adjusting the voltage levels of optical sensors such as photo diodes, though not limited thereto, nor to provide any additional circuit for adjusting the optical detection timing. Therefore, since the liquid crystal device 1 according to the present embodiment of the invention does not require any more complex circuit configuration of a control circuit that controls the operation of optical sensors, it features simplified circuit configuration of the device as a whole.

Next, with reference to FIG. 15, an explanation is given below of another advantage of the method for identifying the position of a pointing object such as a finger or the like according to the present embodiment of the invention. As illustrated in FIG. 15, it is assumed herein that an image portion of a foreign object K that is, needless to say, not the same object as the finger F is contained in each of the images P1′ and P2′. In such a condition, the image portion of the foreign object K typically constitutes a noise that could decrease the precision in the positional identification of the pointing object. However, in the method for identifying the position of a pointing object according to the present embodiment of the invention, which can be performed by the liquid crystal device 1, the noise image portion of the foreign object K is cancelled in the process of calculating a finite difference value between the brightness data of the Image P1′ and the brightness data of the image P2′. Therefore, the noise image portion of the foreign object K does not appear in the resultant image P12′. Thus, with the method for identifying the position of pointing means according to the present embodiment of the invention, which can be performed by the liquid crystal device X, it is possible to eliminate a noise component that has an adverse possibility of decreasing accuracy in identifying the position of the pointing means. By this means, it is possible to identify the position of the pointing means with a high precision.

As explained above, the liquid crystal device 1 according to the present embodiment of the invention, and the method for identifying the position of pointing means according to the present embodiment of the invention, which can be performed by the liquid crystal device 1, make it possible to identify the position of pointing means on the display surface thereof accurately with a simple circuit configuration regardless of the relative optical intensities or outside light and light-source light. Since the liquid crystal device 1 according to the present embodiment of the invention is capable of detecting the position of pointing means accurately, a user can input various kinds of information therein with a high precision.

### 2: Electronic Apparatus

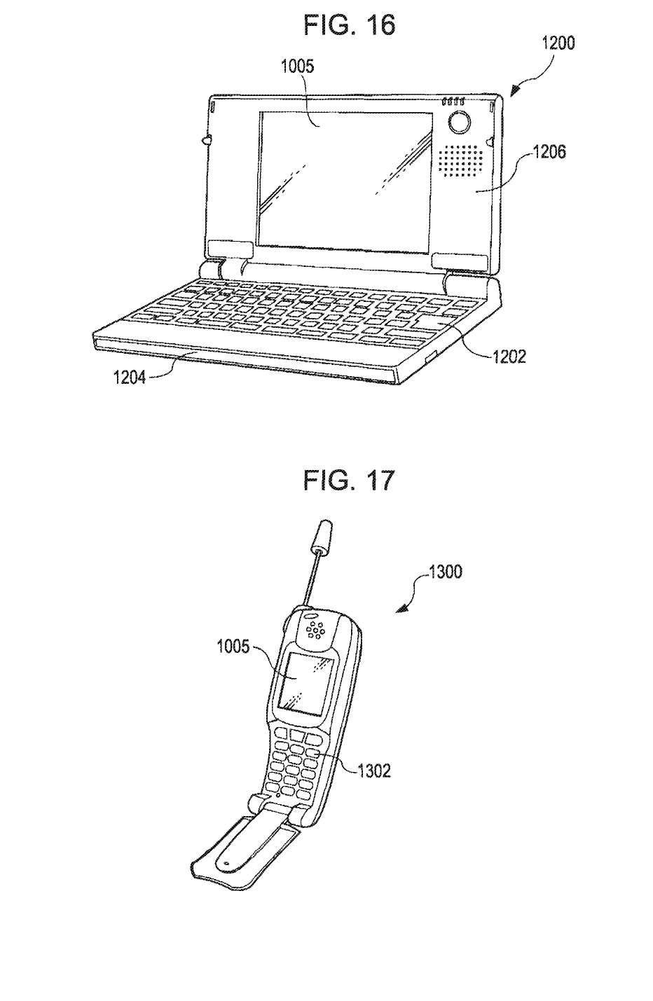

Next, with reference to FIGS. 16 and 17, an exemplary embodiment of an electronic apparatus that is provided with the liquid crystal device described above is explained below.

FIG. 16 is a perspective view that schematically illustrates an example of a mobile personal computer to which the liquid crystal device described above is applied. As illustrated in FIG. 16, a personal computer 1200 is made up of a computer main assembly 1204, which is provided with a keyboard 1202, and a liquid crystal display unit 1206 to which the above-described liquid crystal device is applied. The Liquid crystal display unit 1206 is made up of a liquid crystal panel 1005 and a backlight that is attached to the rear surface of the liquid crystal panel 1005. The liquid crystal display unit 1206 has a touch panel input function. Having a high numerical aperture, the liquid crystal display unit 1206 features enhanced display quality.

Next, an explanation is given below of another exemplary implementation of the invention where the liquid crystal device described above is applied to a mobile phone. FIG. 17 is a perspective view that schematically illustrates a mobile phone, which is an example of an electronic apparatus according to the present embodiment of the invention. As illustrated in FIG. 13, a mobile phone 1300 is provided with a reflective-type liquid crystal device 1005, which has the same configuration as that of the liquid crystal device described above, together with a plurality of manual operation buttons 1302. The mobile phone 1300 features a high numerical aperture and enhanced image display quality. In addition, a user can input information into the mobile phone 1300 with a high precision by, for example, touching the display surface thereof with a finger, which is a non-limiting example of various kinds of pointing means.

What is claimed is:

1. A display device comprising:
a light source that emits a plurality of light-source lights having intensities different from one another at points in time different from one another from a back side opposite a display surface that is pointed by pointing means toward the display surface;
a detecting section that is provided at the back side and functions to detect a plurality of reflected lights, which are obtained as a result of reflection of the plurality of light-source lights by the pointing means; and
an identifying section that identify the position of the pointing means on the basis of each of a plurality of third images by calculating a finite difference value between brightness data of a first image that is generated on the basis of one reflected light among the plurality of reflected lights and brightness data of each of a plurality of second images that is generated on the basis of a plurality of other reflected lights among the plurality of reflected lights, the above-mentioned plurality of other reflected lights having an intensity that differs from that of the above-mentioned one reflected light, and then by generating each of the plurality of third images on the basis of the corresponding one of the plurality of calculated finite difference values.

2. The display device according to claim 1, wherein the identifying section identifies the position of the pointing means by calculating an average value of the respective center coordinates of image portions of the pointing means contained in the plurality of the third images.

3. The display device according to claim 1, further comprising:
a substrate that is provided between the light source and the display surface; and
a plurality of pixel units that constitutes a display region over the substrate,
wherein the detecting section has a plurality of light-sensitive elements each of which is formed inside a non-open region that provides isolation between one open region and another open region of the pixel units in the display region.

4. The display device according to claim 1, wherein the light source further functions as, in addition to its function as a detection light source, a display light source that emits display light for displaying an image in accordance with an image signal on the display surface.

5. The display device according to claim 1 wherein the light source includes light emitting diodes.

6. An electronic apparatus that is provided with the display device according to claim 1.
